(19) United States
(12) Patent Application Publication
(10) Pub. No.: US 2011/0302768 A1
(43) Pub. Date: Dec. 15, 2011

(54) PROCESSING METHOD OF STATORS

(75) Inventors: Ronggui Tian, Jiangsu (CN); Minjian Cao, Jiangsu (CN); Wenjun Ben, Jiangsu (CN)

(73) Assignee: WHITE (CHINA) DRIVE PRODUCTS, CO., LTD

(21) Appl. No.: 13/156,389

(22) Filed: Jun. 9, 2011

(30) Foreign Application Priority Data
Jun. 10, 2010 (CN) 201010196865.1

(51) Int. Cl. H02K 15/02

(52) U.S. Cl. 29/596

(57) ABSTRACT

A processing method of stator, comprising the following steps: Step 100: Forming a stator blank out of a standard bar stock through cold extruding; Step 200; Turning the excircle, the end faces and the sealing groove of the stator blank prepared in step 100, so as to obtain a semi-finished product of stator; Step 300: Performing precision broaching on the inner bore of the semi-finished product of stator prepared in step 200, so as to obtain a finished product of stator. The processing method of stator provided in this invention has the following advantages: The blank cutting allowance is small. The broach is simple to manufacture and of low grinding cost. It is not necessary to turn the internal bore, and the parts have sound heat-treatment performance, and the fatigue resistance of material is improved. Cold extruding technology is adopted so that fluidity of the material is improved. More than one sequences of spheroidizing annealing are inserted in the cold-extruding process so that particles of the material texture are further refined and coarse grain occurrences are reduced in the subsequent processes of carburization and tempering and the fatigue resistance of the material is significantly improved.

This application claims the priority benefit of pending Chinese patent application No. 201010196865.1, filed Jun. 10, 2010, the disclosure of which is included in its entirety herein.

### FIELD OF THE INVENTION

The present invention relates to a processing method of stator, in particular, it relates to a processing method of the stator of WP series motor with cold extruding and precision broaching processes, which pertains to the technical field of product machining design and manufacturing.

### DESCRIPTION OF THE PRIOR ART

WP series motor is a cycloid hydraulic motor with shaft current distribution. It has such advantages as compact volume, big torque, high efficiency and simple structure. Its major components include shell, output shaft, stator-rotor pair, separation disc, rear cover and linkage rod, wherein the stator-rotor pair, as the power source of the motor, is the core part of the motor. Meanwhile, it requires the most complicated processing compared with all the other components, and its quality has significant influence on the performance of a whole motor.

The existing stator-rotor pair of a WP motor is an integral structure. It is made of 20CrMnTiH material and is treated with carburization and quenching so as to reduce internal leakage and abrasion in operating process. On the other hand, such integral structure brings about certain difficulty in processing. Conventionally, the manufacturing process of the stator and rotator pair is as follows: Selecting standard bar stock of 20CrMnTiH and forging the same at temperature of 1050° C. with forging pressure of 630 ton; Next, quenching and tempering the forged workpiece; Then, through a series of processing steps including turning the excircle, the two end faces and the sealing groove, boring inner hole and broaching internal cavity and other processes, the finished product is obtained.

The major bottleneck of the prior art consists in the big allowance in broaching process. Firstly, to ensure the efficiency of the primary broaching, it is necessary to customize a broaching lathe with an extended travel of 2,300 mm. With the estimated cost being about 50% higher than standard machines, very few such broaching lathes with such extended travel are available in domestic market. Secondly, the extended travel of the broaching lathe requires longer broaches. At present, the manufacturing and grinding length for a common broach available in domestic market is 1800 mm-2000 mm. Very few domestic manufacturers has the processing capability of up to 2,300 mm travel length. The price of a single broach is about RMB70000, and the broach is easily yielding and difficult for grinding. The expense for a grinding is about RMB5000. Both the manufacturing and grinding cycles vary depending on the manufacturers.

To sum up, although the processing method of prior art involves a shorter manufacturing process, less complicated processing steps and less initial investment, it has the following disadvantages: Blank processing involves big allowance, with the single side broaching thickness being 8.3 mm. The manufacturing of the broach is complicated, and manufacturing and grinding cost is high. Broach chattering may easily occur in the process of turning of the bore of the big displacement stator, leading to low cutting efficiency.

### SUMMARY OF THE INVENTION

The technical object of the present invention is to provide a processing method of stators such as to overcome the deficiencies of the prior art. The processing method of stators provided in this invention has the following advantages: The blank cutting allowance is small with single side cutting allowance being 0.3 mm-0.5 mm. It is unnecessary to customize a broaching lathe, and the broach is simple to manufacture and requires low grinding cost. It is not necessary to turn the internal bore, and the part has sound heat-treatment performance, and the fatigue resistivity of material is improved. The broaching process is simplified, and the broach length is shortened. Cold extruding technology is adopted, so that the fluidity of material is improved. Furthermore, more than one sequences of spheroidizing annealing are inserted in the cold-extruding process so that particles of the material texture are further refined and the occurrences of coarse grain are reduced in the subsequent processes of carburization and tempering and the fatigue resistivity of material is greatly improved.

The technical object of the present invention is achieved by adopting the following technical solution:

A processing method of stator, comprising the following steps:

Step 100: Forming a stator blank out of a standard bar stock through coal extruding;

Step 200: Turning the excircle, the end faces and the sealing groove of the stator blank prepared in step 100, so as to obtain a semi-finished product of stator;

Step 300: Performing precision broaching on the inner bore of the semi-finished product of stator prepared in step 200, so as obtain the finished product of stator.

The step 100 specifically comprises:

Step 101: Cutting, selecting φ70-100 mm 20CrMnTiH standard bar stock and cutting it into bar segments in length of 50-70 mm;

Step 102: Blank making, turning the surface of the bar segments cut in step 101, so as to remove the oxidized surface;

Step 103: The first annealing at annealing temperature of 750° C.-850° C., with the temperature being held for 35-55 hours;

Step 104: The first softening treatment comprising phosphate treatment and soap treatment, the phosphate treatment being performed prior to the soap treatment;

Phosphate treatment: Soaking the annealed bar segments in common phosphonation liquid at soaking temperature of 50° C.-90° C. for 5-20 minutes;

Soap treatment: Coating the surface of the phosphate treated bar segments with a saponifying powder at coating temperature of 50° C.-90° C.;

Step 105: Hole pressing: pressing at the center of the bar segment treated in the above steps to form blind hole of a diameter of φ30-45 mm and a depth of 70-90 mm;

After the Hole pressing, the workpiece has a length of 70-100 mm and the same outside diameter as the blank obtained after step 102 blank making;

Step 106: Flash edge punching: punching to remove the blind hole left in step 105 and to form a through-holed annular workpiece, the workpiece formed has the same outside diameter as the blank obtained after step 102 blank making, an inside diameter of 30-45 mm and a total length of 70-100 mm;

Step 107: The second annealing at annealing temperature of 750° C.-850° C., with temperature being held for 35-55 hours;

Step 108: The second softening treatment comprising phosphate treatment and soap treatment, the phosphate treatment being performed prior to the soap treatment;

Phosphate treatment: Soaking the annealed bar segments in common phosphonation liquid at soaking temperature of 50° C.-90° C. for 5-20 minutes;

Soap treatment: Coating the surface of the phosphate treated bar segment with a saponifying powder at a coating temperature of 50° C.-90° C.;

Step 109: Die cavity pressing: performing the second pressing on the bar stock segment treated in the above step to form an internal die cavity from the annular through hole and to form a stator blank having a diameter of φ80-100 mm and a length of 100-150 mm.

In step 101, the segmenting of standard bar stock is operated with a GW4028 sawing machine. In step 102, the blank making is operated with a C6140 lathe. In step 105, the blind hole pressing is operated with a pressing machine with pressure of 400-600 ton. In step 106, punching of the flash edge is operated with a punching machine with punching force of 63 ton. In step 103 and step 107, the annealing is operated with a RJ-90 vacuum well type annealing furnace with annealing temperature being 780° C. and temperature being held for 48 hours. In step 104 and step 108, the phosphonation temperature is 80° C., the phosphonation time is 10 minutes, and the saponification temperature is 80° C.

Said step 200 specifically comprises:

Step 201: Truing the stator blank with one of its end faces being perpendicular to the inner cavity formed through pressing in step 109, and turning the excircle, the end face of one end and the sealing groove while ensuring said verticality of said end face to the die cavity;

Step 202: Truing the stator blank by clamping the already turned excircle with the inner cavity being perpendicular with another end face of the stator blank, and turning said another end faces, sealing groove and excircle while simultaneously ensuring the verticality of the under-processing end face to the inner cavity.

Step 300 specifically comprises: broaching the inner bore, with the maximum cutting thickness for single side of inner cavity ranging from 0.3 mm to 0.5 mm.

For the convenience of disassembly and grinding operations, the broaching of inner bore is operated with a self-standing type broach that is made of high-speed steel material and is 1150 mm long, and the connection handle is made of common material and has a total length of 90 inches. The effective saw teeth number of the broach is 43, and the maximum tooth rise is 0.02 mm.

To sum up, the present invention has the following advantages: The blank cutting allowance is small, with single side cutting allowance being 0.3 mm-0.5 mm. It is not necessary to customize the broaching machine, and the broach is simple to manufacture and is of low cost. It is not necessary to turn the internal bore, and the part has sound heat-treatment performance, and the fatigue resistivity of the material is improved. The broaching process is simplified, and the broach length is shortened. Cold extruding technology is adopted, so that the fluidity of material is improved. Furthermore, more than one sequences of spheroidizing annealing are inserted in the cold-extruding process, so that the particles of material texture are further refined and the occurrences of coarse grain are reduced in the subsequent processes of carburization and tempering and the fatigue resistivity of material is greatly improved.

The technical solution of the present invention is elaborated below in combination with the attached drawings and the specific embodiments.

### BRIEF DESCRIPTION OF THE DRAWINGS

FIG. 1 is the overall processing flow chart of the present invention;

FIG. 2 is the specific processing flow chart of the processing step 100 according to the present invention.

### DETAILED DESCRIPTION OF THE PREFERRED EMBODIMENTS

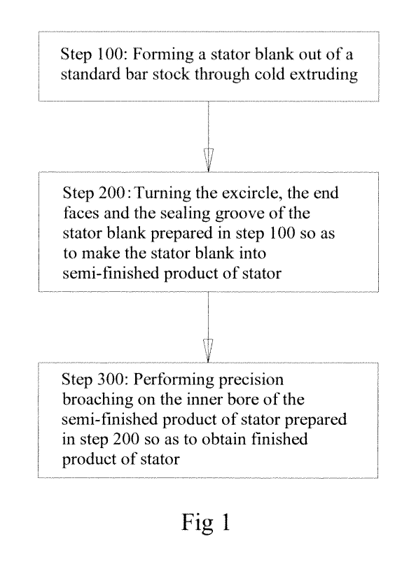

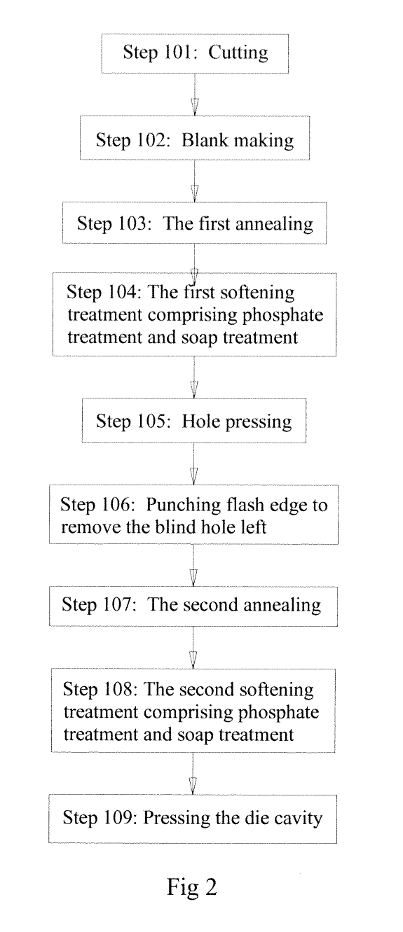

FIG. 1 is the overall processing flow chart of the present invention. FIG. 2 is the specific processing flow chart of step 100 according to the present invention. As shown in FIG. 1 in combination with FIG. 2, the present invention provides a processing method of stators, comprising the following steps:

Step 100: Forming a stator blank out of a standard bar stock through coal extruding;

Step 100 specifically comprises the following steps:

Step 101: Cutting: Selecting a φ70-100 mm 20CrMnTiH standard bar stock and cutting it into bar segments in length of 50-70 mm. In this step, a GW4028 sawing machine is normally adopted to cut the standard bar stock, and of course other similar cutting devices can also be adopted.

Step 102: Blank making, turning the surface of the bar segments cut in step 101, so as to remove the oxidized surface. In this step, the blank making is operated with a C6140 turning lathe or a similar device. There is no specific requirement for the thickness of the removed oxidized surface, and the purpose of this step is to remove the unfavorable substances for the subsequent process.

Step 103: First annealing. In this step, the annealing is operated with a RJ-90 vacuum well type annealing furnace at the annealing temperature of 750° C.-850° C., with the optimal annealing temperature being 780° C. and the temperature being held for 35-55 hours, and the optimal temperature holding time being 48 hours.

Step 104: The first softening treatment comprising phosphate treatment and soap treatment, the phosphate treatment being performed prior to the soap treatment;

Phosphate treatment: Soaking the annealed bar segments in common phosphonation liquid at soaking temperature of 50° C.-90° C. for 5-20 minutes, the optimal phosphonation temperature being 80° C., and the optimal phosphonation duration being 10 minutes;

Soap treatment: Coating the surface of the phosphate treated bar segment with a saponifying powder at coating temperature of 50° C.-90° C., the optimal saponification temperature being 80° C.

Step 105: Hole pressing, namely, pressing at the center of the bar segment treated in the above steps to form a blind hole of a diameter of φ30-45 mm and depth of 70-90 mm. After the hole pressing, the workpiecet has a length of 70-100 mm and the same outside diameter as the blank obtained after step 102 blank making. In this step, a pressing machine is adopted for the hole pressing with the pressure being 400-600 tons. This step is implemented as one step of sequential pressings so as to effectively prevent excessive deformation of the material.

Step 106: Punching the flash edge to remove the blind hole left in step 105 and to form a through-holed annular part, and this part has the same outside diameter as the blank obtained after the step of blank making, its inside diameter being 30-45 mm and its total length being 70-100 mm;

Step 107: The second annealing, the annealing in this step is operated with a RJ-90 vacuum well type annealing furnace at the annealing temperature of 750° C.-850° C., with the optimal annealing temperature being 780° C. and the temperature being held for 35-55 hours, the optimal temperature holding time being 48 hours.

Step 108: The second softening treatment, comprising phosphate treatment and soap treatment, the phosphate treatment being performed prior to the soap treatment;

Phosphate treatment: Soaking the annealed bar segments in common phosphonation liquid at soaking temperature of 50° C.-90° C. for 5-20 minutes, the optimal phosphonation temperature being 80° C., and the optimal phosphonation duration being 10 minutes;

Soap treatment: Coating the surface of the phosphate treated bar segment with a saponifying powder at coating temperature of 50° C.-90° C., the optimal saponification temperature being 80° C.

Step 109: Die cavity pressing, namely performing the second pressing on the bar segment treated in the above steps to form the internal die cavity from the annular through hole and to form a stator blank having a diameter of φ80-100 mm and a length of 100-150 mm.

Then, performing step 200: Turning the excircle, the end faces and sealing groove of the stator blank prepared in the step 100, so as to obtain a semi-finished product of stator;

The step 200 specifically comprises the following steps:

Step 201: Truing the stator blank with one of its end faces being perpendicular to the inner cavity formed through pressing in step 109, and turning the excircle, said one of its end faces and the sealing groove while ensuring said verticality of said end face to the die cavity;

Step 202: Truing the stator blank by clamping the already turned excircle with the inner cavity being perpendicular with another end face of the stator blank, and turning said another end face, sealing groove and excircle while simultaneously ensuring the verticality of the under-processing end face to the inner cavity.

Finally, performing step 300: Performing precision broaching on the inner bore of the semi-finished product of the stator prepared in step 200, so as to obtain the finished product of stator. Specifically, said step 300 comprises the following step: broaching the inner bore, the maximum single side cutting thickness of the inner cavity being 0.3 mm-0.5 mm.

It is noted that, the annealing processes in steps 103 and 107 are performed to remove the residual stress of raw material and to refine the crystal grains of the material. The softening treatment processes in steps 104 and 108 are performed to reduce the frictional resistance in the subsequent pressing process, so as to improve the fluidity of material. Therefore, in the whole processing flow, the annealing and softening treatments should be performed at least once prior to the two pressing processes respectively. Certainly, the annealing and the softening treatment processes can be performed for many times according to the requirements of product processing.

According to the present invention, the broaching of inner bore is operated with a self-standing type broach, which is 1150 mm long and is made of high-speed steel material having high rigidity and not easily pliable. The connection handle is made of common material and has a total length of 90 inches. The effective teeth number of the broach is 43, and the maximum tooth rise is 0.02 mm. Adopting such self-standing broach is for convenient disassembly, low grinding cost, sound rigidity, simple operation and applicability for ordinary machine tool.

The processing method of stator of the present invention is described in detail with the following embodiment.

First, selecting a φ90 mm 20CrMnTiH standard bar stock and cutting it into bar segments in length of 61 mm using a GW4028 sawing machine. Turning the surface of the bar segments using a C6140 turning machine so as to remove the oxidized surface layer. After the surface turning treatment, the bar segment has a diameter of 89.5 mm and a length of 61 mm. The annealing is operated with a RJ-90 vacuum well type annealing furnace with annealing temperature being 780° C.±10° C. and temperature being held for 48 hours. Following the first annealing, the first softening treatment is performed, which comprises a phosphate treatment and a soap treatment, with the phosphate treatment being performed prior to the soap treatment. For phosphate treatment, soaking the annealed bar segments in common phosphonation liquid for 10 minutes with the phosphonation temperature being 80° C. Then, for soap treatment, coating the surface of the phosphate treated bar segment at coating temperature of 85° C.±5° C. A pressing machine is used to make the hole pressing, specifically, pressing out a blind hole at the center of the bar segment that has been treated in the previous step with pressure of 400 ton. The blind hole so pressed out has a diameter of φ39 mm and a depth of 80 mm. After the hole pressing, the workpiece has a length of 61 mm, and its outside diameter being the same as its outside diameter at the time of blank making. Then, flash edge is punched to remove the blind hole left in step 105, and the workpiece is formed into a through-holed annular part having the same outside diameter as the outside diameter at the time of blank making, an inside diameter of 39 mm and a total length of 85 mm. Then, make the second annealing and the second softening treatment with the same processing parameters and the same processing equipments adopted at the time of the first annealing and first softening treatments, of which the details will not be repeated hereto. Then perform die cavity pressing, specifically perform the second pressing on the bar stock segment treated in the above step to form the internal die cavity from the annular through hole and to form a stator blank having a diameter of 87 mm and a length of 130 mm.

Then, perform turning of the excircle, the end faces and the sealing groove of the stator blank that has been treated in the above step, so as to obtain a semi-finished product of stator. Specifically, Truing the stator blank with one of its side end faces being perpendicular to the inner cavity formed through pressing in step 109, and turning the excircle, said one end face of the end faces and the sealing groove while ensuring said verticality of said end face to the die cavity. Next, truing the stator blank by clamping the already turned excircle with the inner cavity being perpendicular with another end face of the stator blank, and turning said another end face, the sealing groove and the excircle while simultaneously ensuring the verticality of the under-processing end face to the inner cavity.

Finally, perform precision broaching on the inner bore of the semi-finished product of stator that has been treated in the previous step, so as to obtain the finished product of stator. Specifically, it comprises the following step: broaching the inner bore, with the maximum single side cutting thickness of inner cavity being 0.3 mm-0.5 mm.

To sum up, the processing method of stator provided in the present invention has the following advantages: The blank cutting allowance is small, with single side cutting allowance being 0.3 mm-0.5 mm. It is not necessary to customize special broaching machine, and the broach is simple to manufacture and is of low grinding cost. It is not necessary to turn the internal bore, and the part has sound heat-treatment performance, and the fatigue resistivity of material is improved. The processing method provided in the present invention primarily utilizes the good plasticity of 20CrMnTiH material, and the turning load of broach is tremendously reduced and the broaching process is simplified. Firstly, the broach length is shortened from 2300 mm to 1300 mm, and the broach is changed from the original high-speed steel integrated broach into a connection handled self-standing broach, and the price of each single broach is reduced to about RMB20000, and the expense of one grinding is reduced to RMB500. That is, the expenses are considerably saved for both the manufacturing of broach and the grinding at later stage. Secondly, cold extruding technology is adopted, so that the fluidity of material is improved. Furthermore, more than one sequences of spheroidizing annealing are inserted in the cold-extruding process, so that the particles of material texture are further refined and the occurrences of coarse grain in the subsequent processes of carburization and tempering are reduced and the fatigue resistivity of material is greatly improved.

Finally it must be mentioned as follows: said embodiments are merely used to describe rather than define the technical solutions of the present invention. Although the detailed description of the present invention is provided with reference to preferred embodiments, those skilled in the art should understand that all the modifications or equivalent substitutions to the present invention without deviation from the spirit and range of present invention shall be covered by the claims of present invention.

1. A processing method of stator, characterized in that said processing method of stator comprises the following steps:
Step 100: Forming a stator blank out of a standard bar stock through coal extruding;
Step 200: Turning the excircle, the end faces and the sealing groove of the stator blank prepared in step 100 so as to obtain a semi-finished product of stator;
Step 300: Performing precision broaching on the inner bore of the semi-finished product of stator prepared in step 200, so as to obtain the finished product of stator.

2. The processing method of stator according to claim 1, wherein said step 100 specifically comprises:
Step 101: Cutting: selecting φ70-100 mm 20CrMnTiH standard bar stock and cutting it into bar segments in length of 50-70 mm;
Step 102: Blank making, turning the surface of the bar segments cut in step 101 to remove the oxidized surface layer;
Step 103: The first annealing at annealing temperature of 750° C.-850° C., said temperature being held for 35-55 hours;
Step 104: The first softening treatment comprising phosphate treatment and soap treatment, the phosphate treatment being performed prior to the soap treatment;
Phosphate treatment: Soaking the annealed bar segments in common phosphonation liquid for 5-20 minutes, the soaking temperature being 50° C.-90° C.;
Soap treatment: Coating the surface of the phosphate-treated bar segment with a saponifying powder, the coating temperature being 50° C.-90° C.;
Step 105: Hole pressing: pressing to form blind hole at the center of the bar segment treated in the above mentioned steps, the blind hole formed having a diameter of φ30-45 mm and depth of 70-90 mm. After the pressing, the workpiece resulted has a length of 70-100 mm and the same outside diameter as the outside diameter of the blank prepared after step 102;
Step 106: Punching to remove the blind hole left in step 105 and to form a through-holed annular part, the part resulted having the same outside diameter as the blank prepared after step 102, the inside diameter being 30-45 mm and total length of the resulted part being 70-100 mm;
Step 107: The second annealing at annealing temperature of 750° C.-850° C., said temperature being held for 35-55 hours;
Step 108: The second softening treatment comprising phosphate treatment and soap treatment, the phosphate treatment being performed prior to the soap treatment;
Phosphate treatment: Soaking the annealed bar segment in common phosphonation liquid for 5-20 minutes, the soaking temperature being 50° C.-90° C.;
Soap treatment: Coating the surface of the phosphate treated bar segment with a saponifying powder, coating temperature being 50° C.-90° C.;
Step 109: Die cavity pressing: performing the second pressing on the bar stock segment treated in the above step to form the internal die cavity from the annular through hole and to form a stator blank having a diameter of φ80-100 mm and a length of 100-150 mm.

3. The processing method of stator according to claim 2, wherein in step 101, the standard bar stock is segmented with a GW4028 sawing machine.

4. The processing method of stator according to claim 2, wherein in step 102, the blank making is performed with a C6140 turning lathe.

5. The processing method of stator according to claim 2, wherein in step 105, the blind hole is formed using a pressing machine with pressure of 400-600 tons.

6. The processing method of stator according to claim 2, wherein in step 106, the punching of flash edge is performed using a punching machine with punching force of 63 tons.

7. The processing method of stator according to claim 2, wherein in step 103 and step 107, the annealing is performed with a RJ-90 vacuum well type annealing furnace with annealing temperature being 780° C., and the temperature being held for 48 hours.

8. The processing method of stator according to claim 2, wherein in step 104 and step 108, the phosphonation temperature is 80° C., the phosphonation time is 10 min, and the saponification temperature is 80° C.

9. The processing method of stator according to claim 2, wherein said step 200 specifically comprises:
Step 201: Truing the stator blank with one of its side end faces being perpendicular to the inner cavity formed through pressing in step 109, and turning the excircle, the end face of one end and the sealing groove while ensuring said verticality of said end face to the die cavity;
Step 202: Truing the stator blank by clamping the already turned excircle with the inner cavity being perpendicular with another end face of the stator blank, and turning said another end face, the sealing groove and the excircle while simultaneously ensuring the verticality of the under-processing end face to the inner cavity.

10. The processing method of stator according to claim 1, wherein said step 300 specifically comprises: broaching the inner bore, with the maximum cutting thickness for a single side of inner cavity ranging from 0.3 mm to 0.5 mm.

11. The processing method of stator of claim 10, wherein the broaching of inner bore is performed with a free-standing broach that is made of a high-speed steel material and is 1150 mm long; the connection handle is made of ordinary material and is 90 inches long; the effective number of saw teeth of the broach is 43; the maximum tooth rise is 0.02 mm.
